(19) United States
(12) Patent Application Publication
(10) Pub. No.: US 2013/0110672 A1
(43) Pub. Date: May 2, 2013

(54) APPARATUS AND METHOD FOR PAYMENT IN BROADCAST RECEIVER USING MOBILE TERMINAL HAVING CARD READER FUNCTION

(71) Applicant: Samsung Electronics Co., Ltd, Gyeonggi-do (KR)

(72) Inventors: Do-Jun Yang, Gyeonggi-do (KR); Cheol-Ju Hwang, Gyeonggi-do (KR); Sun-Eung Park, Gyeonggi-do (KR); Jin-Goo Seo, Gyeonggi-do (KR)

(73) Assignee: Samsung Electronics Co., Ltd, Gyeonggi-do (KR)

(21) Appl. No.: 13/661,906

(22) Filed: Oct. 26, 2012

(30) Foreign Application Priority Data
Oct. 27, 2011 (KR) 10-2011-0110546

(51) Int. Cl. G06Q 20/40; G06Q 30/06

(52) U.S. Cl. 705/26.8; 705/44

(57) ABSTRACT

A method for payment in a television using a mobile terminal. In the method, a first server is requested to transmit an item of interest. The item of interest is received from the first server, so that a user selects at least one item among items of interest. A mobile terminal is requested to transmit payment information of the selected item and the payment information is received from the mobile terminal. The payment information is received, and a second server is requested to approve payment.

### CROSS-REFERENCE TO RELATED APPLICATION(S) AND CLAIM OF PRIORITY

The present application is related to and claims the benefit under 35 U.S.C. §119(a) to a Korean Patent Application filed in the Korean Intellectual Property Office on Oct. 27, 2011 and assigned Serial No. 10-2011-0110546, the entire disclosure of which are hereby incorporated by reference.

### TECHNICAL FIELD OF THE INVENTION

As information technology develops, an age where a multimedia medium passively provided an image to a user has evolved into an age where a user can actively select various media. For example, multitasking functions that allows a user to view a movie and simultaneously access the Internet to retrieve information are now commercialized.

### BACKGROUND OF THE INVENTION

Devices for receiving a broadcast signal to provide an image to a user are developing rapidly. A representative example includes a television which can be generally seen in a household, a restaurant, a public place, and the like. A television provides various types of information to a user. As specialized channels such as on-line shopping, home shopping, and the like, are established, a television improves the convenience of a user and a seller.

However, when a user sees goods or services in which the user is interested while viewing a broadcast channel, such as the above-described home shopping channel, it may be inconvenient for the user to actually purchase the goods in which the user is interested. For example, for the user to purchase the goods of interest, the user may need to make a phone call to communicate with a sales representative or access a web page of a seller via the Internet to input payment information.

Therefore, development of a method for allowing a user to easily purchase goods of interest while viewing a television is required.

### SUMMARY OF THE INVENTION

To address the above-discussed deficiencies of the prior art, it is a primary object to provide at least the advantages described below. Accordingly, an aspect of the present disclosure is to provide a payment apparatus and a method thereof, for immediately purchasing goods or a service of interest while viewing a television using a mobile terminal having a card reader function.

Another aspect of the present disclosure is to provide a payment apparatus and a method thereof, for protecting a user's personal information by allowing a server and a television to perform encrypted short distance communication therebetween.

Still another aspect of the present disclosure is to provide a payment apparatus and a method thereof, for meeting a user's diversity by providing various shopping applications to the user.

In accordance with an aspect of the present disclosure, a method for operating a broadcast receiver for payment is provided. The method includes requesting a first server to transmit an item of interest, and receiving the item of interest from the first server to determine at least one item selected by a user among items of interest; requesting a mobile terminal to transmit payment information of the selected item; receiving the payment information from the mobile terminal; and requesting a second server to approve payment in response to the reception of the payment information.

In accordance with another aspect of the present disclosure, a method for operating a mobile terminal for payment is provided. The method includes receiving a request of a payment information from a broadcast receiver ; requesting a user to input the payment information; receiving the payment information from the user; and transmitting the payment information to the broadcast receiver in response to the reception of the payment information from the user.

In accordance with further another aspect of the present disclosure, an apparatus of a broadcast receiver for payment is provided. The apparatus includes an application module configured to request a first server to transmit an item of interest and receive the item of interest from the first server; a display unit configured to allow a user to select at least one item from items of interest; a terminal communication processing module configured to request a mobile terminal to transmit payment information of the selected item and receive the payment information from the mobile terminal; a payment processing module configured to process the received payment information; and a server communication processing module configured to request a second server to approve payment in response to the reception of the payment information.

In accordance with further another aspect of the present disclosure, an apparatus of a mobile terminal for payment is provided. The apparatus includes a card communication processing module configured to receive a request of a payment information from a broadcast receiver, request a user to input the payment information, and receive the payment information from the user; and a broadcast receiver communication processing module configured to transmit the payment information to the broadcast receiver in response to the reception of the payment information from the user.

Other aspects, advantages and salient features of the disclosure will become apparent to those skilled in the art from the following detailed description, which, taken in conjunction with the annexed drawings, discloses exemplary embodiments of the disclosure.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating an embodiment of a system for purchasing goods of interest using an application according to an embodiment of the present disclosure;

FIG. 2 is a view illustrating a sequence for purchasing goods of interest using an application according to an embodiment of the present disclosure;

FIG. 3 is a view illustrating a sequence for purchasing goods of interest according to an embodiment of the present disclosure;

FIG. 4 is a block diagram illustrating a television according to an embodiment of the present disclosure;

FIGS. 5A and 5B are block diagram illustrating a first server and a second server according to an embodiment of the present disclosure; and

FIG. 6 is a block diagram illustrating a mobile terminal according to an embodiment of the present disclosure.

Throughout the drawings, like reference numerals will be understood to refer to like parts, components and structures.

### DETAILED DESCRIPTION OF THE INVENTION

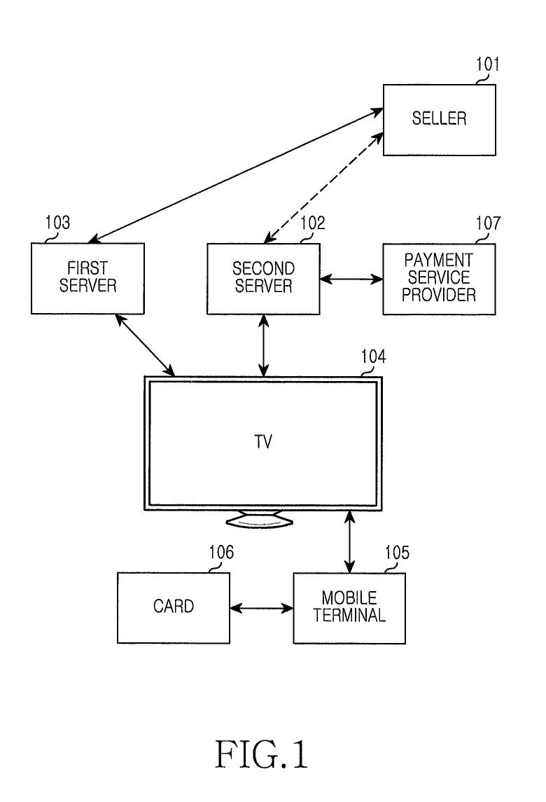

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

FIG. 1 is a view illustrating an embodiment of a system for purchasing goods of interest using an application according to an embodiment of the present disclosure. A seller 101 illustrated in FIG. 1 denotes a person or business that intends to sell goods or services via home shopping or online. A first server 103 manages goods or services information for allowing a user to purchase an item of interest via a television 104, transfers an item of interest selected by the user to the television 104, and manages information regarding purchase by a user.

A second server 102 relays payment between the television 104 and a payment service provider 107, and performs a payment-by-agent function. The television 104 receives broadcast signals and provides an image. Though FIG. 1 illustrates the television 104, any device may replace the television as far as it can receive broadcast signals and provide an image. The payment service provider 107 informs the seller 101 whether a payment means provided with respect to a requested amount is usable. For example, the payment service provider 107 may be a credit card company, a bank company, a telecommunication company, and the like.

A mobile terminal 105 denotes a device that can perform a contact or non-contact communication function with a user's card. For example, the mobile terminal may be a remote controller of a television, a mobile phone, and the like. The user's card 106 denotes a card having a contact or non-contact communication function with the mobile terminal 105. That is, the user's card may be mounted within the mobile terminal, or may be a plastic Integrated Circuit (IC) card or a mobile card that supports Near Field Communication (NFC) and Radio Frequency (RF) communication such as MIFARE and FELICA.

According to an embodiment of the present disclosure, when the seller 101 develops an application and registers the application in the second server 102, a user installs an application of interest to the television 104 and executes the same among applications stored in the second server 102 to purchase an item of interest. That is, for the above embodiment, the seller 101 should develop an application and register the application in the second server 102, and a user should install an application of interest to the user's television 104 and execute the same among applications stored in the second server 102 to purchase an item of interest.

According to an embodiment of the present disclosure, a user does not need to purchase an item of interest using an application developed by the seller 101. Instead, the user receives information of the item of interest from the first server 103 to purchase the item of interest. More specifically, an embodiment is realized in the form related to an Electronic Program Guide (EPG) of the television.

As illustrated in FIG. 1, a dotted line connecting the seller 101 with the second server 102 denotes the above-described embodiment in which the seller 101 develops an application and registers the same in the second server 102, and a user installs an application of interest using the television 104. In contrast, according to the above-described another embodiment, the seller 101 does not need to develop an application and register the same in the second server 102, so that there is no mutual connection relation between the seller 101 and the second server 102. That is, a user may immediately receive information regarding an item of interest stored in the first server 103 in connection with program information via the television 104 to purchase the item of interest.

In the above two embodiments, subsequent processes for selecting and purchasing an item for interest are the same. More specifically, when a user selects an item of interest and selects a command for purchasing the selected item of interest or a purchase button, the television 104 requests the mobile terminal 105 to transmit payment information. The mobile terminal 105 receives a payment information request from the television 104 and requests a user's card 106 to transmit the payment information. The user's card 106 extracts the payment information and then transmits the extracted payment information to the mobile terminal 105. The mobile terminal 105 that has received the payment information from the user's card 106 transmits the payment information to the television 104 that has requested the payment information.

When the television 104 that has received the payment information transmits the payment information to the second server 102, the second server 102 generates a payment message to request the payment service provider 107 to perform payment approval. The payment service provider 107 that has been requested to perform the payment approval transmits a payment approval result to the second server 102, and the second server 102 transmits the payment approval result to the television 104. Therefore, a user may receive the payment approval result via the television 104. After that, when the television 104 transmits the payment approval result to the first server 103, the seller 101 may receive a result that payment of sold goods or services has been completed via the first server 103.

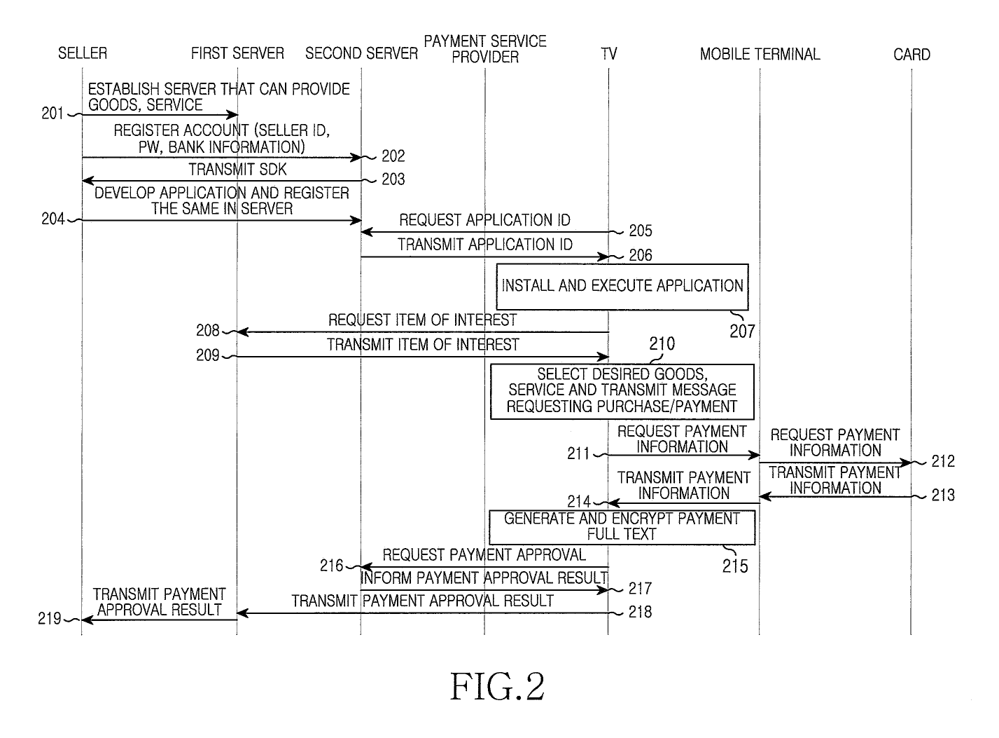

FIG. 2 is a view illustrating a sequence for purchasing goods of interest using an application according to an embodiment of the present disclosure. As illustrated in FIG. 2, a seller establishes a first server that can transmit information of goods or services selected by a user to a television (201). For example, the seller registers and stores information such as product information, prices, sale periods, and the like, of goods or services which the seller desires to sell in the first server. A process for establishing the server is not a process that should be performed first but a process that should be performed until the seller develops an application and registers the application in the second server.

When the seller has established the first server, which can provide goods or services to the seller, the seller registers an account in the second server (202). More specifically, the seller registers an account in the second server by inputting the seller's ID and password with which the seller may access the second server, the seller's hank information, and the like. That is, a process for registering the seller's account in the second server is for integrated management with an application developed by the seller, as described in greater detail below.

When the seller's account has been registered in the second server, the second server transmits a software development kit that can develop an application to the seller (203). The software development kit denotes a set of development tools for allowing a software engineer to make a specific software bundle, a software framework, a hardware platform, a computer system, a game console, an application for an operating system, and the like. The reason why the seller receives the software development kit from the second server is to allow the seller to develop an application. That is, the seller should receive the software development kit as a preposition for developing an application.

After that, the seller who has developed an application registers the developed application in the second server (204). The second server integrates an ID, description, an icon of an application, an ID of the seller, bank information, and an application as a package and manages the same simultaneously with registration of the application. The above application may be developed by a second seller and a third seller, and various applications may be registered in the second server. Therefore, the user may select an application suitable for the user's taste from various applications, so that the user's convenience may improve. The functions of the first server and the second server are clearly discriminated as follows. The first server registers information regarding goods or a service which the seller desires to sell, and transmits information of an item of interest selected by a user to the television. The second server registers the seller's account to register and store an application developed by the seller, and transmits an application selected by a user to the television.

When a user selects a specific application while retrieving various applications registered in the second server, the television requests the second server to transmit an ID of the application selected by the user (205). That is, to receive the application of interest selected by the user among various applications registered and stored in the second server, the television should specify an ID of the application. When the seller registers the application in the second server, the seller is given the ID of the application by the second server.

The second server, which has been requested by the television to transmit an ID of a specific application, extracts the ID of the application from an integrally managed package. When the ID of the specific application requested by the television has been extracted by the second server, the second server transmits the extracted ID of the application to the television (206). This is to permit the user's television to receive the relevant application by specifying the application of interest selected by the user among the various applications registered in the second server as described above.

The television that has received the ID of the application from the second server installs and executes the received application (207). Preferably, the specific application which the television has received from the second server may be automatically installed in the television. In the method for purchasing an item of interest using an application according to an embodiment of the present disclosure, since the television executes an application installed in the television to receive information of an item of interest from the first server, installation and execution of the application may be required.

After that, a user who has executed the application and viewed a home shopping program or an on-line shopping program via the television can receive information of the item of interest from the first server. More specifically, in the situation where goods or services which the user desires to purchase usually are for sale via broadcasting, when the user executes a command for receiving the item of interest or presses an interest item reception button, the television requests the first server to transmit the item of interest (208).

The first server, which has been requested by the television to transmit the item of interest, transmits information regarding the item of interest, that is, the goods or service which the user desires to purchase to the television (209). The item of interest includes a price, a list, a sale period, and the like, of the goods or service selected by the user. That is, the user may receive the information regarding the item of interest from the first server to determine detailed information of the item of interest and determine whether to purchase the goods or service.

The television that has received the item of interest from the first server displays the item of interest on a display unit to allow the user to determine detailed content regarding the item of interest more specifically. After that, the user determines the item of interest, and selects goods or services which the user desires to purchase to make a purchase request. Simultaneously with the purchase request, the television transmits a message requesting payment to the user (210). Preferably, the television may display a short message of a payment request on the display unit of the television, or transmit a voice or audible message requesting payment to the user.

Simultaneously with transmitting the message of a payment request to the user, the television requests a mobile terminal connected with the television via short distance communication such as BLUETOOTH, WiFi, ZIGBEE, and the like, to transmit payment information (211). Conventionally, in a situation where the user finds goods or services of interest while viewing the television, the user may make a phone call to a seller or access an associated web page to purchase the goods or services. In contrast, according to the present disclosure, the user may immediately purchase desired goods or services with manipulation of a mobile terminal connected with the television via the short distance communication. After that, the mobile terminal that has received a payment request from the television initializes a communication mode in order to read the user's card.

The mobile terminal that has been requested to transmit the payment information requests the user's card to transmit the payment information (212). Here, the mobile terminal may be connected with the card via a contact or non-contact manner. That is, the user's card may be mounted within the mobile terminal, or may be a plastic Integrated Circuit (IC) card or a mobile card that supports Near Field Communication (NFC) and Radio Frequency (RF) communication such as MIFARE and FELICA.

The user's card that has been requested by the mobile terminal to transmit the payment information extracts the payment information and transmits the extracted payment information to the mobile terminal (213). The payment information denotes the user's card information which includes a serial number of a card issued by a card company to the user, a valid period of a card, and the like.

The mobile terminal that has received the payment information extracted from the user's card transmits the received payment information to the television (214). As described above, the mobile terminal may be connected with the television via the short distance communication such as BLUETOOTH, WiFi, ZIGBEE, and the like. Particularly, since personal information such as the user's payment information has a danger of being exposed to the outside, the payment information is transmitted from the mobile terminal to the television via an encrypted wireless connection. For example, when using BLUETOOTH among the short distance communications, a code is set between the television and the mobile terminal, so that the user's personal information may be protected.

The television that has received the payment information from the mobile terminal generates a payment full text using the payment information, that is, the user's card information, an ID of the executed application, and purchase information of goods or a service purchased by the user, and encrypts the generated payment full text (215). That is, the television encrypts the payment full text so that the user's payment information may not be exposed to the outside. Here, the payment full text denotes a document on which a seller's information, sale goods, a sale price, a purchaser's card information, and the like, are recorded.

The television transmits the encrypted payment full text to the second server, and requests the second server to approve the payment (216). The second server, which has received the payment request together with the encrypted payment full text, extracts the payment full text and decodes the encrypted payment full text. After that, the second server extracts an ID of the application from the decoded payment full text. A seller's information such as the seller's name, the seller's ID, and the like, can be extracted from the ID of the application. When the ID of the application has been extracted, the second server extracts the seller's information via a database of the second server using the extracted ID of the application. The second server transmits the seller's information extracted from the second server, the payment information included in the payment full text received from the television, and the user's card information to the payment service provider.

The payment service provider that has received the seller's information, the payment information, and the user's card information from the second server transmits a payment approval result to the second server. The second server, which has received the payment approval information from the payment service provider, transmits the payment approval result to the television (217). The television that has received the payment approval result from the second server displays the payment approval result on the display unit to transmit a message saying that payment of the goods or service purchased by the user has been completed. That is, the second server transmits the payment approval result to the television, so that the user may determine the payment approval result via the television.

After that, when the television transmits the payment approval result received from the second server to the first server (218), the seller may determine that sale of the specific goods or service has been completed via the first server (219).

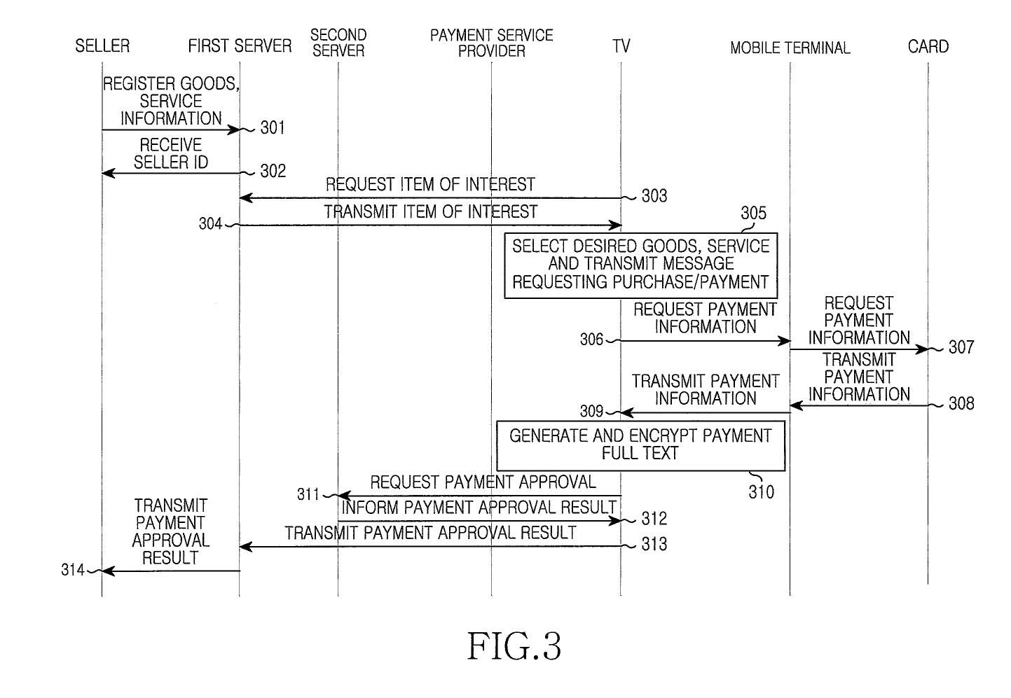

FIG. 3 is a view illustrating a sequence for purchasing goods of interest according to an embodiment of the present disclosure. As illustrated in FIG. 3, a seller registers information regarding goods or services which the seller intends to sell in a first server (301). For example, the seller registers and stores information such as product information, prices, sale periods, and the like, of goods or services which the seller intends to sell in the first server.

When the seller registers the information regarding the goods or services to sell in the first server, the seller is given an ID of the seller by the first server (302). The reason why the seller is given the ID of the seller is to permit a second server to extract information of the seller from the ID of the seller, as described below.

After that, in a situation where a user finds an item of interest while viewing home shopping or on-line shopping via a television, when the user selects the item of interest, the television requests the first server to transmit information regarding the item of interest (303). More specifically, the request of the item of interest denotes a request of detailed information regarding the item of interest. The request of the item is to request a channel ID and a program ID. For example, a user may move a focus to a relevant program on an EPG of the television to input a specific remote controller key or may input a specific remote controller key while viewing a relevant program.

The first server, which has been requested by the television to transmit the channel ID and the program ID, transmits information regarding the channel ID, the program ID, the seller's ID, and the item of interest to the television (304). The information regarding the item of interest may include a price, a list, a sale period, and the like, of goods or services. That is, the user may receive the information regarding the item of interest from the first server to determine detailed information of the item of interest and determine whether to purchase the goods or service.

The television that has received the item of interest from the first server displays the item of interest on a display unit to allow a user to determine a detailed content regarding the item of interest more specifically. After that, the user determines the item of interest, and selects goods or services which the user desires to purchase to make a purchase request. Simultaneously with the purchase request, the television transmits a message requesting payment to the user (305). Preferably, the television may display a short message of a payment request on the display unit of the television or transmit a voice or audible message requesting payment to the user.

Simultaneously with transmitting the message of the payment request to the user, the television requests a mobile terminal connected with the television via the short distance communication such as BLUETOOTH, WiFi, ZIGBEE, and the like, to transmit payment information (306). Conventionally, in a situation where the user finds goods or a service of interest while viewing the television, the user may make a phone call to a seller or access an associated web page to purchase the goods or service. In contrast, according to the present disclosure, the user may immediately purchase desired goods or service with manipulation of a mobile terminal connected with the television via the short distance communication. After that, the mobile terminal that has received a payment request from the television initializes a communication mode in order to read the user's card.

The mobile terminal that has been requested to transmit the payment information requests the user's card to transmit the payment information (307). Here, the mobile terminal may be connected with the card via a contact or non-contact manner. That is, the user's card may be mounted within the mobile terminal, or may be a plastic IC card or a mobile card that supports NFC and RF communication such as MIFARE and FELICA.

The user's card that has been requested by the mobile terminal to transmit the payment information extracts the payment information and transmits the extracted payment information to the mobile terminal (308). The payment information denotes the user's card information which may include a serial number of a card issued by a card company to the user, a valid period of a card, and the like.

The mobile terminal that has received the payment information extracted from the user's card transmits the received payment information to the television (309). As described above, the mobile terminal may be connected with the television via the short distance communication such as BLUETOOTH, WiFi, ZIGBEE, and the like. Particularly, since personal information such as the user's payment information has a danger of being exposed to the outside, the payment information is transmitted from the mobile terminal to the television via an encrypted wireless connection. For example, when using BLUETOOTH among the short distance communications, a code is set between the television and the mobile terminal, so that the user's personal information may be protected.

The television that has received the payment information from the mobile terminal generates a payment full text using the payment information, that is, the user's card information, an ID of the seller, and purchase information of goods or services purchased by the user, and encrypts the generated payment full text (310). That is, the television encrypts the payment full text so that the user's payment information may not be exposed to the outside.

The television transmits an encrypted payment full text to the second server, and requests the second server to approve the payment (216). The second server, which has received the payment request together with the encrypted payment full text, extracts the payment full text and decodes the encrypted payment full text. After that, the second server extracts an ID of the seller from the decoded payment full text. A seller's information such as the seller's name, bank information, and the like, can be extracted from the ID of the seller. When the ID of the seller has been extracted, the second server extracts the seller's information via a database of the second server using the extracted ID of the seller. The second server transmits the seller's information extracted from the second server, the payment information included in the payment full text received from the television, and the user's card information to the payment service provider.

The payment service provider that has received the seller's information, the payment information, and the user's card information from the second server transmits a payment approval result to the second server. The second server, which has received the payment approval information from the payment service provider, transmits the payment approval result to the television (312). The television that has received the payment approval result from the second server displays the payment approval result on the display unit to transmit a message saying that payment of the goods or service purchased by the user has been completed. That is, the second server transmits the payment approval result to the television, so that the user may determine the payment approval result via the television.

After that, when the television transmits the payment approval result received from the second server to the first server (313), the seller may determine that sale of the specific goods or service has been completed via the first server (314).

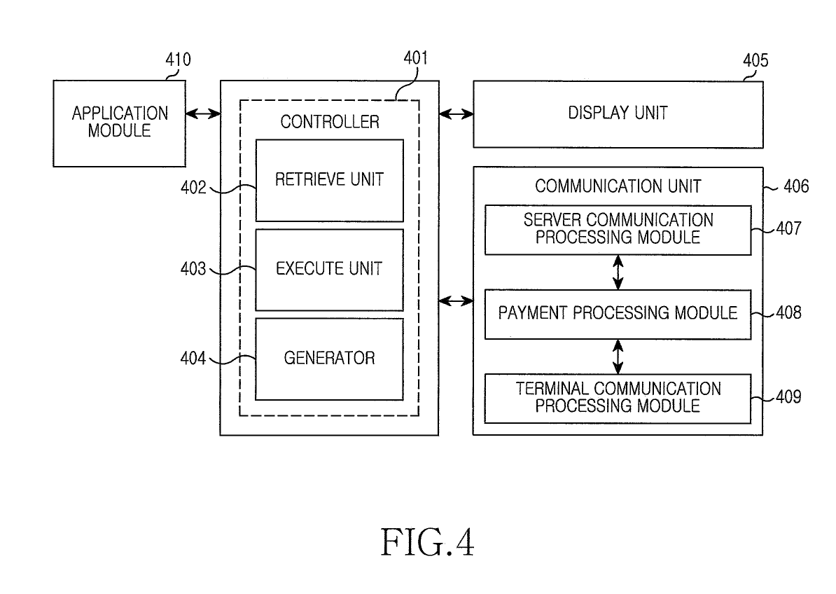

FIG. 4 is a block diagram illustrating a television according to an embodiment of the present disclosure. As illustrated in FIG. 4, the television may include a controller 401, a display unit 405, a communication unit 406, and an application module 410. According to the present disclosure, the controller 401 may include a retrieve unit 402, an execute unit 403, and a generator 404. In addition, the communication unit 406 may include a server communication processing module 407, a payment processing module 408, and a terminal communication processing module 409.

The controller 401 processes an overall operation of the television. The controller 401 may include the retrieve unit 402, the execute unit 403, and the generator 404.

The retrieve unit 402 retrieves at least one application list stored in the second server. That is, the retrieve unit 402 retrieves a list of applications in order to install an application in which the user is interested among applications registered in the second server by the seller.

The execute unit 403 receives an ID of an application from the second server to install and execute the application. In the method for purchasing an item of interest using the application according to the present disclosure, the user may install and execute an application developed by the seller on the television to receive information regarding the item of interest from the first server.

The generator 404 generates an encrypted payment full text using at least one of an ID of the application, the user's card information, information of goods or services to purchase, and an ID of the seller. That is, the television encrypts the payment full text so that the user's payment information may not be exposed to the outside. More specifically, an apparatus for purchasing an item of interest using the application developed by the seller encrypts a payment full text using an ID of the application, purchase information, and the user's card information. An apparatus for purchasing an item of interest, where the apparatus cooperates with an EPG of the television encrypts a payment full text using the ID of the seller, purchase information, and the user's card information.

The display unit 405 displays state information of a mobile terminal, a menu screen, and storage information under control of the controller 401. For example, the display unit 405 includes a touch screen. In addition, the display unit 405 receives at least one item among the user's items of interest, receives a purchase request regarding a selected item from the user, and transmits a message requesting payment to the user.

For voice and data communication, the communication unit 406 processes a signal transmitted/received via an antenna. According to the present disclosure, the communication unit 406 may include the server communication processing module 407, the payment processing module 408, and the terminal communication processing module 409.

The server communication processing module 407 requests the second server to approve payment, selects at least one application of interest in an application list, and requests the second server to transmit an ID of the selected application. In addition, the server communication processing module 407 receives a payment approval result from the second server. More specifically, the server communication processing module 407 transmits the payment full text encrypted by the generator 404 to the second server.

The payment processing module 408 processes received payment information.

The terminal communication processing module 409 requests a mobile terminal to transmit payment information of a selected item, and receives the payment information from the mobile terminal. in addition, the terminal communication processing module 409 performs encrypted short distance communication with the mobile terminal to receive the payment information from the mobile terminal. More specifically, the terminal communication processing module 409 is connected with the mobile terminal via the short distance communication such as BLUETOOTH, WiFi, ZIGBEE, and the like.

The application module 410 requests the first server to transmit an item of interest to receive the item of interest. In addition, the application module 410 transmits a received payment approval result to the first server.

In the above block configuration, the controller 401 may perform the overall operation of the television.

Separate configuration and illustration of the controller 401 in an embodiment of the present disclosure is for the purpose of separately describing each function. In some embodiments, all or some of the functions of the television may be processed by the controller 401.

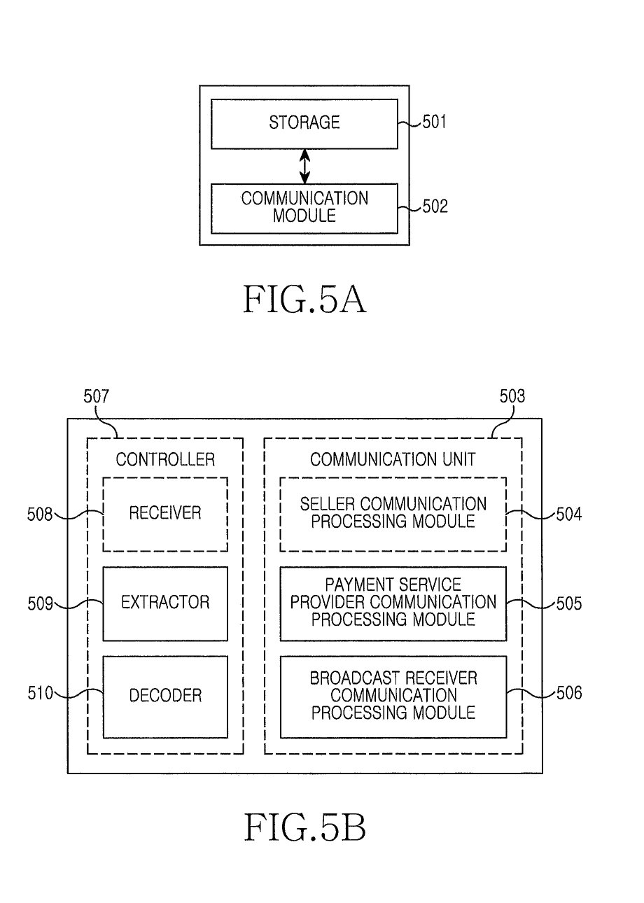

FIGS. 5A and 5B are block diagrams illustrating a first server and a second server according to an embodiment of the present disclosure. FIG. 5A is a block diagram illustrating the first server according to the present disclosure. As illustrated in FIG. 5A, the first server may include a storage 501 and a communication module 502.

The storage 501 may include a program storage for storing a program for controlling an operation of the first server, and a data storage for storing data generated during execution of a program. For example, the storage 501 receives a payment approval result from the television and stores the same.

The communication module 502 is requested by the television to transmit an item of interest and transmits the item of interest to the television.

FIG. 5B is a block diagram illustrating the second server according to the present disclosure. As illustrated in FIG. 58, the second server may include a communication unit 503 and a controller 507. The communication unit 503 may include a seller communication processing module 504, a payment service provider communication processing module 505, and a broadcast receiver communication processing module 506. The controller 507 may include a receiver 508, an extractor 509, and a decoder 510.

The seller communication processing module 504 transmits a software development kit to a seller, and gives an ID to a registered application. More specifically, in an apparatus for purchasing an item of interest using an application developed by a seller, the seller communication processing module 504 transmits a software development kit to the seller, and gives an ID to a registered application. In contrast, in an apparatus for purchasing goods of interest, where the apparatus cooperates with an EPG of the television, the seller communication processing module 504 may be omitted.

The payment service provider communication processing module 505 is requested by the television to approve payment, requests a payment service provider to approve the payment, transmits a seller's information, a payment amount, and card information to the payment service provider, and receives a payment approval result from the payment service provider.

The broadcast receiver communication processing module 506 is requested by the television to transmit an ID of at least one application and transmits the requested ID of the application to the television. In addition, the broadcast receiver communication processing module 506 receives an encrypted payment full text using the requested ID of the application or an ID of a seller, a user's card information, and information of purchased goods or service. In addition, the broadcast receiver communication processing module 506 transmits a payment approval result to the television. More specifically, in an apparatus for purchasing an item of interest using an application developed by a seller, the broadcast receiver communication processing module 506 is requested by the television to transmit an ID of an application of interest, transmits the requested ID of the application to the television, and receives an encrypted payment full text using the requested ID of the application, a user's card information, and information of purchased goods or service. In contrast, in an apparatus for purchasing goods of interest, where the apparatus cooperates with an EPG of the television, the broadcast receiver communication processing module 506 receives the encrypted payment full text using the seller's ID, the user's card information, and information of purchased goods or service.

According to an embodiment of the present disclosure, the controller 507 includes the receiver 508, the extractor 509, and the decoder 510.

The controller 507 controls the second server generally.

The receiver 508 receives a seller's ID, a password, and bank information from the seller, and allows the seller to register at least one application. More specifically, in an apparatus for purchasing an item of interest using an application developed by the seller, the receiver 508 receives the seller's ID, the password, and the bank information, and allows the seller to register at least one application. In contrast, in an apparatus for purchasing goods of interest, where the apparatus cooperates with an EPG of the television, the receiver 508 may be omitted.

The extractor 509 extracts an ID of an application and the seller's ID to extract the seller's information stored in a database. More specifically, in an apparatus for purchasing an item of interest using an application developed by the seller, the extractor 509 extracts the ID of the application to extract the seller's ID stored in the database of the second server. In contrast, in an apparatus for purchasing goods of interest, where the apparatus cooperates with an EPG of the television, the extractor 509 extracts the seller's ID to extract the seller's information stored in the database of the second server.

The decoder 510 extracts a payment full text received from the television to decode an encrypted payment full text. That is, since personal information such as the user's payment information has a danger of being exposed to the outside, the decoder 510 of the second server decodes the encrypted payment full text transmitted from a mobile terminal via an encrypted wireless connection section.

In the above block configuration, the controller 507 may perform an overall function of the second server. Separate configuration and illustration of the controller 507 in an embodiment of the present disclosure is for the purpose of separately describing each function. In some embodiments, all or some of the functions of the second server may be processed by the controller 507.

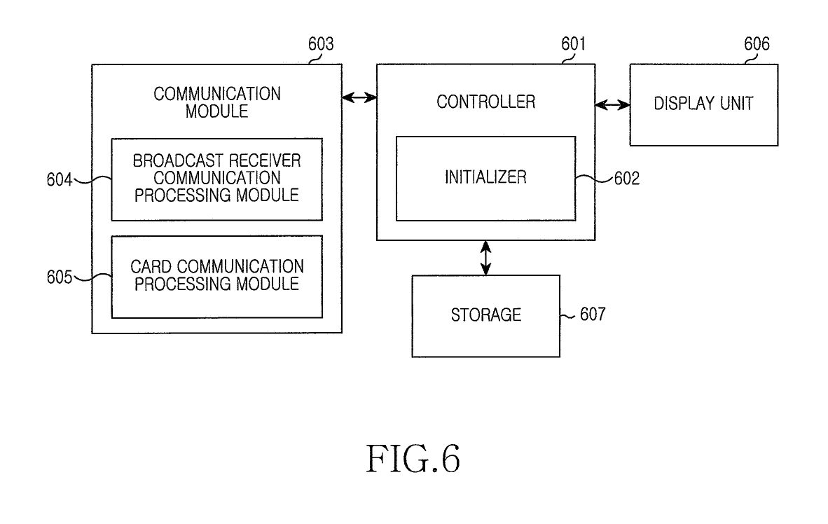

FIG. 6 is a block diagram illustrating a mobile terminal according to an embodiment of the present disclosure. As illustrated in FIG. 6, the mobile terminal may include a controller 601, a communication module 603, a display unit 606, and a storage 607. According to the present disclosure, the controller 601 may include an initializer 602. The communication module 603 may include a broadcast receiver communication processing module 604 and a card communication processing module 605.

The controller 601 controls an overall operation of the mobile terminal. The initializer 602 may be included in the controller 601. The initializer 602 initializes a communication mode of the mobile terminal in order to receive payment information from a card.

For voice and data communication, the communication module 603 processes signals transmitted/received via an antenna. A television communication processing module 604 and a card communication processing module 605 may be included in the communication module 603.

The broadcast receiver communication processing module 604 transmits payment information to a television and performs encrypted short distance communication with the television. More specifically, the broadcast receiver communication processing module 604 of the mobile terminal performs the short distance communication such as BLUETOOTH, WiFi, ZIGBEE, and the like, with the television to receive payment information from the television.

The card communication processing module 605 is requested by the television to transmit payment information, requests a card to transmit the payment information, and receives the payment information from the card. In addition, the card communication processing module 605 requests and receives the payment information via the short distance communication with the card. More specifically, a user's card may an IC card or a mobile card that supports NFC and RF communication such as MIFARE and FELICA.

In the above block configuration, the controller 601 may perform an overall operation of the mobile terminal. Separate configuration and illustration of the controller 601 in an embodiment of the present disclosure is for the purpose of separately describing each function. In some embodiments, all or some of the functions of the mobile terminal may be processed by the controller 601.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for operating a broadcast receiver for payment, the method comprising:
requesting a first server to transmit an item of interest, and receiving the item of interest from the first server to determine at least one item selected by a user among items of interest;
requesting a mobile terminal to transmit payment information of the selected item;
receiving the payment information from the mobile terminal; and
requesting a second server to approve payment in response to the reception of the payment information.

2. The method of claim 1, wherein the item of interest which the first server has been requested to transmit comprises at least one of an item comprising a list, a price, a sale period of goods or services which the user desires to purchase, a channel ID, and a program ID, and
wherein the item of interest received from the first server comprises at least one of an item comprising a list, a price, a sale period of goods or services which the user desires to purchase, a channel ID, a program ID, and a seller ID of the goods or services which the user desires to purchase.

3. The method of claim 1, further comprising:
allowing the user to select to purchase the selected item; and
transmitting a message to the user requesting the user to pay for the item.

4. The method of claim 1, wherein the payment information comprises card information of the user, the card information being received from the user via short distance communication.

5. The method of claim 1, wherein the receiving of the payment information from the mobile terminal comprises:
receiving the payment information from the mobile terminal by performing encrypted short distance communication between the broadcast receiver and the mobile terminal.

6. The method of claim 1, further comprising generating an encrypted payment full text using at least one of an ID of an application, the user's card information, information of purchased goods or services, and a seller's ID to transmit the encrypted payment full text to the second server.

7. The method of claim 1, further comprising:
receiving a payment approval result from the second server; and
transmitting the received payment approval result to the first server.

8. A method for operating a mobile terminal for payment, the method comprising:
receiving a request of a payment information from a broadcast receiver;
requesting a user to input the payment information;
receiving the payment information from the user; and
transmitting the payment information to the broadcast receiver in response to the reception of the payment information from the user.

9. The method of claim 8, wherein the payment information comprises card information of the user,
wherein the receiving of the payment information from the user comprises:
receiving the payment information from the user via short distance communication.

10. The method of claim 8, wherein the transmitting of the payment information to the broadcast receiver comprises transmitting the payment information to the broadcast receiver by performing encrypted short distance communication between the mobile terminal and the broadcast receiver.

11. An apparatus of a broadcast receiver for payment, the apparatus comprising:
an application module configured to request a first server to transmit an item of interest and receive the item of interest from the first server;
a display unit configured to allow a user to select at least one item from items of interest;
a terminal communication processing module configured to request a mobile terminal to transmit payment information of the selected item and receive the payment information from the mobile terminal;
a payment processing module configured to process the received payment information; and
a server communication processing module configured to request a second server to approve payment in response to the reception of the payment information.

12. The apparatus of claim 11, wherein the item of interest which the first server has been requested to transmit comprises at least one of an item comprising a list, a price, a sale period of goods or services which the user desires to purchase, a channel ID, and a program ID, and
wherein the item of interest received from the first server comprises at least one of an item comprising a list, a price, a sale period of goods or services which the user desires to purchase, a channel ID, a program ID, and a seller ID of the goods or services which the user desires to purchase.

13. The apparatus of claim 11, wherein the display unit is configured to receive a request for purchasing the selected item from the user and transmit a message requesting payment to the user.

14. The apparatus of claim 11, wherein the payment information comprises the user's card information, the card information being received from the user via short distance communication.

15. The apparatus of claim 11, wherein the terminal communication processing module is configured to receive the payment information from the mobile terminal by performing encrypted short distance communication with the mobile terminal.

16. The apparatus of claim 11, further comprising a generator configured to generate an encrypted payment full text using at least one of an ID of an application, the user's card information, information of purchased goods or service, and a seller's ID to transmit the encrypted payment full text to the second server.

17. The apparatus of claim 11, wherein the server communication processing module is configured to receive a payment approval result from the second server, and the application module is configured to transmit the received payment approval result to the first server.

18. An apparatus of a mobile terminal for payment, the apparatus comprising:
a card communication processing module configured to receive a request of a payment information from a broadcast receiver, request a user to input the payment information, and receive the payment information from the user; and
a broadcast receiver communication processing module configured to transmit the payment information to the broadcast receiver in response to the reception of the payment information from the user.

19. The apparatus of claim 18, wherein the payment information comprises the user's card information,
wherein the card communication processing module is configured to receive the payment information from the user via short distance communication.

20. The apparatus of claim 18, wherein the broadcast receiver communication processing module is configured to transmit the payment information to the broadcast receiver by performing encrypted short distance communication with the broadcast receiver.
